(19) United States
(12) Patent Application Publication
(10) Pub. No.: US 2008/0235086 A1
(43) Pub. Date: Sep. 25, 2008

(54) Advertisement umbrella

(76) Inventor: Joen-Shen Ma, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/723,415

(22) Filed: Mar. 20, 2007

(51) Int. Cl. G06Q 30/00; A45B 25/20

(52) U.S. Cl. 705/14; 135/33.7

(57) ABSTRACT

An advertisement umbrella includes a central post, a runner, a crown, ribs and associated stretchers, a top sphere and a canopy. The canopy has a multiple layer structure including an outer layer and an inner layer between which an illuminant is installed. The central post includes a tubular member in which batteries are accommodated to supply electricity to the illuminant, allowing light from the illuminant to transmit through the canopy and present colorful advertisement frames consisting of different characters and patterns on the umbrella canopy.

### BACKGROUND OF THE INVENTION

1. Field of the Invention

The present invention generally relates to an umbrella designed for commercial purpose, and in particular to an advertisement umbrella designed to contain an illuminant between an outer canopy and an inner canopy, allowing light to transmit through the canopy and display advertisement frames comprising of characters or different patterns on the umbrella canopy.

2. The Related Arts

The conventional large-sized beach umbrellas and garden umbrellas have similar basic structures, generally made up of a central post, a runner, a crown and a canopy.

The general purposes of the conventional large-sized umbrella are sun-shading, rain-shading, embellishing the landscape and etc. The use of large-sized umbrella in commercial advertisement purposes has never been seen before. Some large-sized umbrellas contain the function of hanging illumination on the shade, such as Christmas decorations, to increase the aesthetic feeling during night time. But installing these externally mounted illuminants consumes additional labor costs, and these illuminants, at the same time, do not provide specific commercial advertisement purposes, and are incapable of bringing out the best advertisement effect of the large-sized umbrella.

Therefore, it is desired to have an improvement of large-sized umbrella that makes use of selectively emitted light to demonstrate advertisement on an umbrella canopy.

### SUMMARY OF THE INVENTION

Thus, the present invention is made to overcome the drawbacks of the conventional large-sized umbrella, and presenting an improved advertisement umbrella.

A primary objective of the present invention is to provide a large-sized umbrella consisting of a canopy of a multiple layer structure. Illuminants are installed between the layers of the canopy structure and allowing the light produced by the illuminants to present advertisement frames consisting of different characters and patterns on the umbrella shade to perform commercial purposes.

Another objective of the present invention is to provide a advertisement umbrella which is capable of presenting a plurality of different types lighting effect to increase the aesthetic feeling during night time. Using the illuminants between the canopy layers, the advertisement umbrella is able to present advertisement frames consisting of different characters and figures, which is capable of increasing the additional commercial benefits of the advertisement umbrella.

To realize the above objectives, the present invention provides an advertisement umbrella having the following technical features.

The advertisement umbrella of the present invention is comprised of a central post, a runner, a crown, ribs and associated stretchers, a top sphere and a multiple-layered canopy.

The canopy of the advertisement umbrella of the present invention has a multiple layer structure consisting of an outer canopy layer, an inner canopy layer, and an illuminant arranged between the outer and inner canopy layers.

The central post of the advertisement umbrella of the present invention comprises a hollow tubular member forming an interior space accommodating batteries therein to provide electricity to the illuminant to light up the illuminant.

The illuminant of the advertisement umbrella of the present invention can be any kind of lighting element, which is arranged between the outer and inner canopy layers, and is arranged into different characters and patterns according to advertisement needs.

Alternatively, an electric circuit is used to control the illuminant to twinkle in different frequencies and colors for realizing change of characters and patterns presented on the umbrella canopy.

When the advertisement umbrella is switched on to start supplying power to the illuminant, colorful advertisement frames consisting of different characters and patterns are presented on the umbrella shade, to accomplish the objectives of advertisement.

The illuminant is arranged into different characters and patterns in advance, and thus the advertisement umbrella of the present invention can be used in commercial advertisement purpose. In the same way, the umbrella of the present invention can also be designed into different figures and used as a garden umbrella or a beach umbrella.

### BRIEF DESCRIPTION OF THE DRAWINGS

The present invention will be apparent to those skilled in the art by reading the following description of preferred embodiments thereof, with reference to the attached drawings, wherein:

FIG. 1 shows a perspective view of an advertisement umbrella in accordance with a preferred embodiment of the present invention, wherein light transmits from an illuminant presents advertisement frames consisting of different characters and patterns on an umbrella canopy;

FIG. 2 shows a side elevational of the advertisement umbrella of the present invention with the canopy shown in phantom line to illustrate inside details;

FIG. 3 shows an enlarged view of a portion of the advertisement umbrella illustrated in FIG. 2, a central post of the umbrella being partially broken to show a battery set arranged inside the central post;

FIG. 4 shows a perspective view of an advertisement umbrella in accordance with another embodiment of the present invention that is powered by solar energy; and

FIG. 5 shows a perspective view of an advertisement umbrella in accordance with a further embodiment of the present invention that is powered by electrical power from an electrical main.

### DETAILED DESCRIPTION OF THE PREFERRED EMBODIMENTS

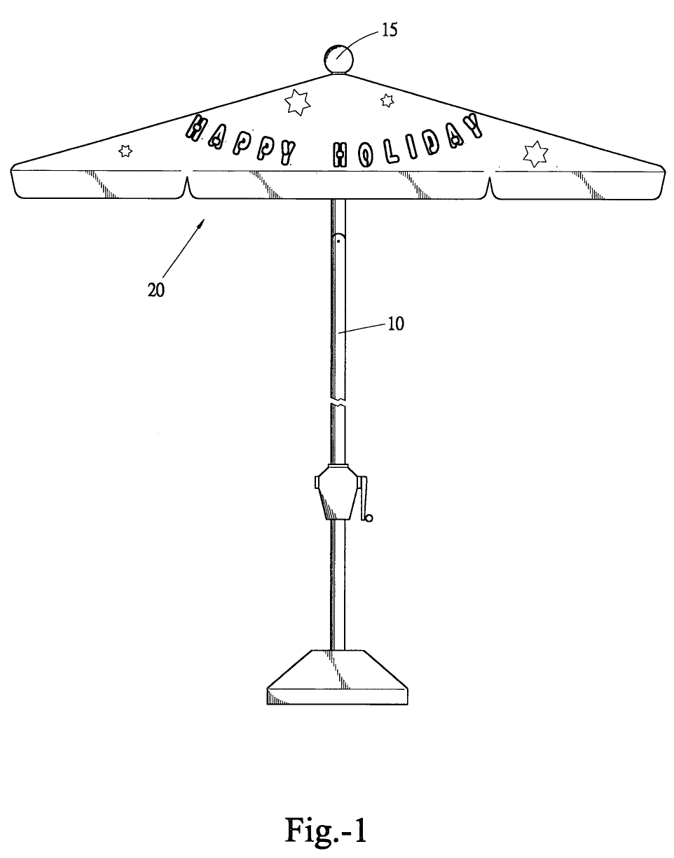

With reference to the drawings and in particular to FIG. 1, which shows a perspective view of an advertisement umbrella constructed in accordance with a preferred embodiment of the present invention, the advertisement umbrella of the present invention, as illustrated in the drawings, employs light from a built-in illuminant to present advertisement frames consisting of different characters and patterns on an outer surface of the umbrella shade or canopy.

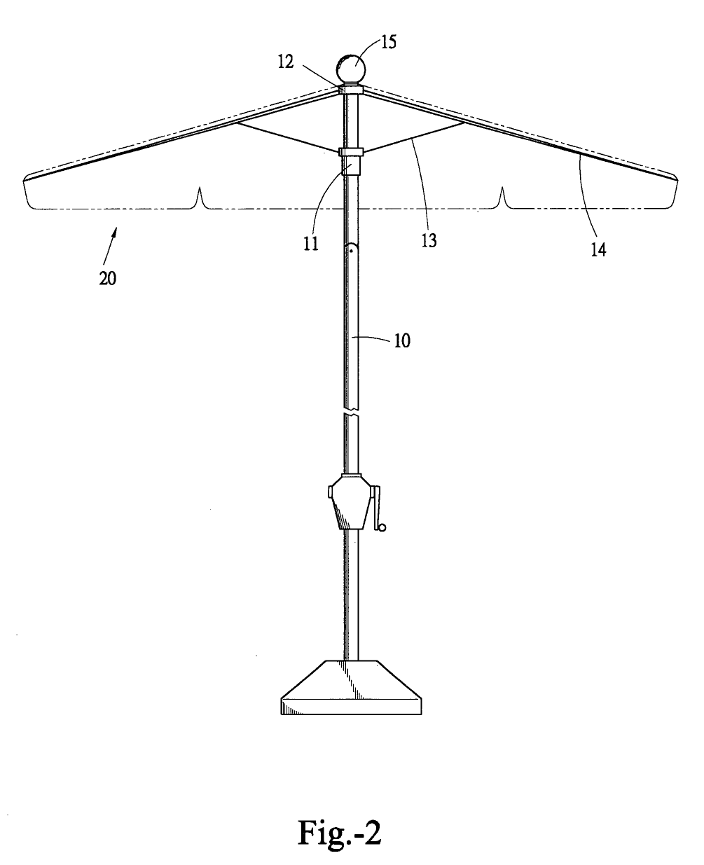

FIG. 2 shows a side elevational view of the advertisement umbrella of the present invention with a canopy shown in phantom lines to illustrate inside details.

As shown in FIGS. 1 and 2, the advertisement umbrella in accordance with the present invention comprises a central post 10, a runner 11, a crown 12, a plurality of ribs 13, a plurality of stretchers 14 corresponding to the ribs 13 respectively, a top sphere 15 and a canopy 20.

As shown in FIG. 2, the crown 12 is fixed on a top end of the central post 10. The runner 11 is slidable along the central post 10 in a controlled manner. The runner 11 supports and drives the ribs 13 through the stretchers 14 to selectively open and close the canopy 20.

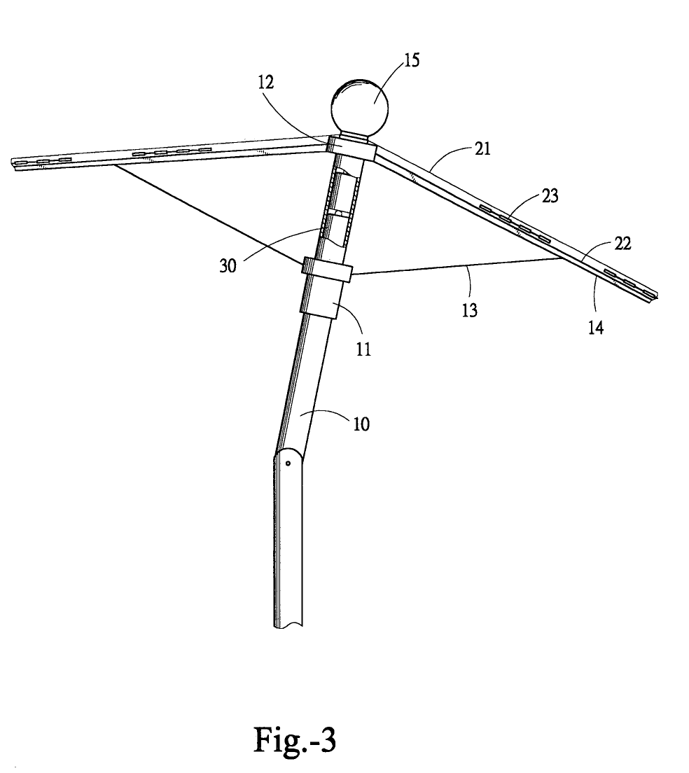

FIG. 3 shows an enlarged view of a portion of the umbrella illustrated in FIG. 2. In FIG. 3, the central post 10 is partially shown in cross-sectional form to illustrate a battery set, designated with reference numeral 30, disposed inside the central post 10. In this respect, the central post 10 may comprise a tubular member forming an interior space for accommodating the battery set 30, which may comprise a number of batteries or rechargeable cells.

As shown in FIGS. 2 and 3, the canopy 20 has a multiple layer structure comprising an outer canopy layer 21, an inner canopy layer 22, and an illuminant 23 interposed between the outer and inner canopy layers 21, 22.

As mentioned above, the central post 10 comprises a hollow tubular member forming an interior space in which the battery set 30 comprising at least one battery and preferably a number of batteries is disposed to provide electricity to and thus light the illuminant 23.

The illuminant 23 can be any type of lighting element. These lighting elements are installed between the outer and inner canopy layers 21, 22 and are arranged into different characters and patterns according to advertisement needs.

If desired, an electronic control circuit (not shown) can be used to control the illuminant 23 to emit light in different fashions, such as twinkling in different frequencies and colors and at the same time changing the presented characters and patterns.

When the advertisement umbrella is switched on to start supplying power from the battery set 30 to the illuminant 23, colorful advertisement frames consisting of different characters and patterns are present on the umbrella shade, to accomplish the objectives of advertisement.

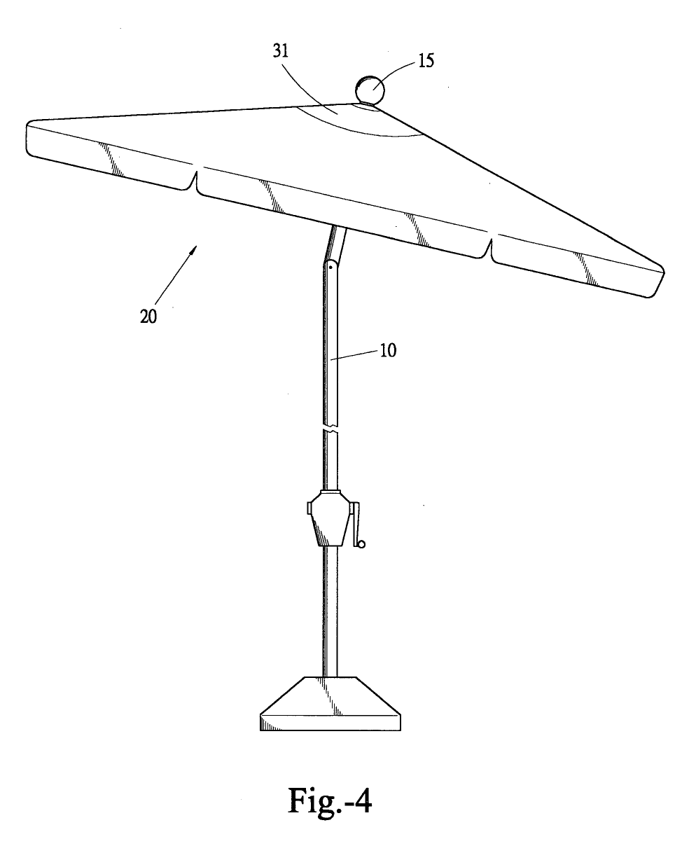

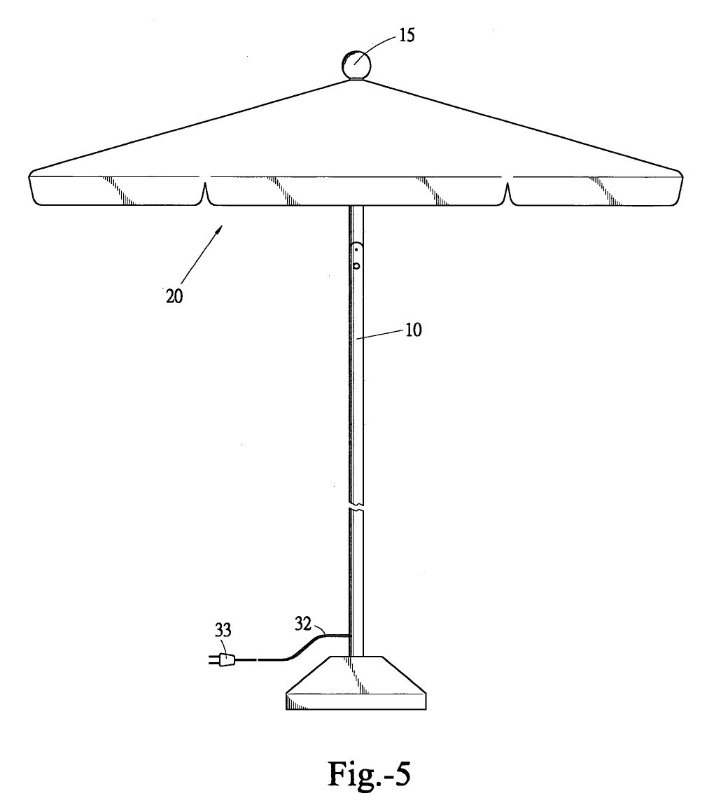

FIG. 4 shows a perspective view of an advertisement umbrella in accordance with an embodiment of the present invention, which is powered by solar energy. And, FIG. 5 shows a perspective view of an advertisement umbrella in accordance with an embodiment of the present invention, which is powered through main power line.

As shown in FIG. 4, in order to improve the electricity providing efficiency of the battery set 30, a solar energy collecting panel 31 is added to the advertisement umbrella. By transforming solar energy radiating on the umbrella into electricity to charge the battery set 30, the battery set 30 that consists of rechargeable cells or batteries in the embodiment can be improved with respect to performance thereof. Preferably, the solar energy collecting panel 31 is arranged at a location on the umbrella facing the sun, for example, on an outer surface of the umbrella canopy 20 close to the top sphere 15, or directly mounted on the top sphere 15, in order to receive enough sunlight.

As shown in FIG. 5, a power cable 32 having a free end forming a plug 33 is implemented to the umbrella to supply power from a main power line to charge the battery set 30, which in the embodiment comprises rechargeable batteries or cells.

In accordance with the present invention, the illuminant 33 is arranged into different characters and patterns in advance, or is alternatively controlled by an electronic control circuit to demonstrate different characters and patterns. Thus the advertisement umbrella of the present invention can be used in commercial advertisement purpose. In the same way, the umbrella of the present invention can also be designed into different figures and use as a garden umbrella or a beach umbrella.

Although the present invention has been described with reference to the preferred embodiments thereof, it is apparent to those skilled in the art that a variety of modifications and changes may be made without departing from the scope of the present invention which is intended to be defined by the appended claims.

1. An advertisement umbrella comprising a central post, a runner, a crown, ribs, stretchers, a top sphere and a canopy, wherein:
the canopy has a multiple layer structure comprising an outer layer extending over an inner layer, at least a portion of the outer layer being spaced from the inner layer;
an illuminant captured in the space between the inner and outer layers;
a central post comprising a hollow tubular member forming an interior space that accommodates a battery set for supplying electricity to light the illuminant; and
the illuminant comprising at least one lighting element disposed between the outer and inner layers of the canopy and arranged into different characters and patterns according to advertisement needs.

2. The advertisement umbrella as claimed in claim 1 further comprising a control circuit electrically connected to and controlling the illuminant to light in a controlled manner so as to demonstrate characters and patterns in different fashion.

3. The advertisement umbrella as claimed in claim 1 further comprising a solar energy collecting panel electrically connected to the battery set for supplying electrical power that is converted from solar energy to the battery set.

4. The advertisement umbrella as claimed in claim 1 further comprising a power cable electrically connected to the battery set and having a plug adapted to selectively connect to a main power line to supply electrical power from the main power line to the battery set.
